(19) United States
(12) Patent Application Publication
(10) Pub. No.: US 2021/0218995 A1
(43) Pub. Date: Jul. 15, 2021

(54) VIDEO ENCODING/DECODING METHOD AND APPARATUS

(71) Applicants: ELECTRONICS AND TELECOMMUNICATIONS RESEARCH INSTITUTE, Daejeon (KR); IUCF-HYU (INDUSTRY-UNIVERSITY COOPERATION FOUNDATION HANYANG UNIVERSITY), Seoul (KR)

(72) Inventors: Hong Chang SHIN, Daejeon (KR); Ho Min EUM, Daejeon (KR); Gwang Soon LEE, Daejeon (KR); Jin Hwan LEE, Daejeon (KR); Jun Young JEONG, Seoul (KR); Kug Jin YUN, Daejeon (KR); Jong Il PARK, Seoul (KR); Jun Young YUN, Seoul (KR)

(73) Assignees: ELECTRONICS AND TELECOMMUNICATIONS RESEARCH INSTITUTE, Daejeon (KR); IUCF-HYU (INDUSTRY-UNIVERSITY COOPERATION FOUNDATION HANYANG UNIVERSITY), Seoul (KR)

(21) Appl. No.: 17/147,021

(22) Filed: Jan. 12, 2021

(30) Foreign Application Priority Data
Jan. 13, 2020 (KR) 10-2020-0004455
Jan. 11, 2021 (KR) 10-2021-0003220

(51) Int. Cl. H04N 19/597

(52) U.S. Cl. CPC H04N 19/597

(57) ABSTRACT

A video encoding/decoding method and apparatus is provided. The image decoding method includes acquiring image data of images of a plurality of views, determining a basic view and a plurality of reference views among the plurality of views, determining a pruning order of the plurality of reference views, and parsing the image data based on the pruning order and decoding an image of the basic view and images of the plurality of reference views.

### CROSS REFERENCE TO RELATED APPLICATION

The present application claims priority to KR10-2020-0004455, filed Jan. 13, 2020 and KR10-2021-0003220, filed Jan. 11, 2021, the entire contents of which is incorporated herein for all purposes by this reference.

### BACKGROUND OF THE INVENTION

### 1. Field of the Invention

The present disclosure relates to a video encoding/decoding method and apparatus. More particularly, the present disclosure relates to a video encoding/decoding method and apparatus for determining a pruning order based on importance of images of a plurality of reference views when the images of the plurality of reference views are used, and a recording medium storing a bitstream generated by the video encoding/decoding method or apparatus of the present disclosure.

### 2. Description of the Related Art

Recently, the demand for high resolution and quality images such as high definition (HD) or ultra-high definition (UHD) images has increased in various applications. As the resolution and quality of images are improved, the amount of data correspondingly increases. This is one of the causes of increase in transmission cost and storage cost when transmitting image data through existing transmission media such as wired or wireless broadband channels or when storing image data. In order to solve such problems with high resolution and quality image data, a high efficiency image encoding/decoding technique is required.

### SUMMARY OF THE INVENTION

An object of the present disclosure is to provide a video encoding/decoding method and apparatus for determining a pruning order of a plurality of view images.

In addition, another object of the present disclosure is to provide a video encoding/decoding method and apparatus for determining importance of a plurality of view images.

In addition, another object of the present disclosure is to provide a video encoding/decoding method and apparatus capable of efficiently managing image data.

In addition, another object of the present disclosure is to provide a video encoding/decoding method and apparatus for providing a natural omnidirectional video.

In addition, another object of the present disclosure is to provide a video encoding/decoding method and apparatus capable of improving image compression efficiency and image synthesis quality.

In addition, another object of the present disclosure is to provide a recording medium storing a bitstream generated by a video encoding/decoding method or apparatus of the present disclosure.

According to the present disclosure, a video encoding method may include acquiring images of a plurality of views, determining a basic view and a plurality of reference views among the plurality of views, determining a pruning order of the plurality of reference views, and performing pruning between an image of the basic view and images of the plurality of reference views based on the pruning order.

The video encoding method may further include determining a protection mask based on an important area of the images of the plurality of views.

An area determined as the protection mask may not be pruned.

The protection mask may have an arbitrary shape.

The determining of the pruning order of the plurality of reference views may include determining importance of the plurality of reference views, and determining the pruning order of the plurality of reference views based on the importance.

The determining of the importance of the plurality of reference views may include giving a weight to each pixel in the images of the plurality of reference views, and determining the importance of the plurality of reference views based on the weight.

The giving of the weight may include giving the weight to each pixel in the image based on at least one of a position of an object, a distance from a camera or width and depth values of an occluded area.

The determining of the importance of the plurality of reference views may include determining the importance of the plurality of reference views based on a target position indicating a position of a virtual camera of a user.

The determining of the basic view and the plurality of reference views among the plurality of views may include determining the basic view based on a change in target position indicating a position of a virtual camera of a user.

A video decoding method may include acquiring image data of images of a plurality of views, determining a basic view and a plurality of reference views among the plurality of views, determining a pruning order of the plurality of reference views, and parsing the image data based on the pruning order and decoding an image of the basic view and images of the plurality of reference views.

The video decoding method may further include determining a protection mask based on an important area of the images of the plurality of views.

An area determined as the protection mask may not be pruned.

The protection mask may have an arbitrary shape.

The determining of the pruning order of the plurality of reference views may include determining importance of the plurality of reference views, and determining the pruning order of the plurality of reference views based on the importance.

The determining of the importance of the plurality of reference views may include giving a weight to each pixel in the images of the plurality of reference views, and determining the importance of the plurality of reference views based on the weight.

The giving of the weight may include giving the weight to each pixel in the image based on at least one of a position of an object, a distance from a camera or width and depth values of an occluded area.

The determining of the importance of the plurality of reference views may include determining the importance of the plurality of reference views based on a change in target position indicating a position of a virtual camera of a user.

The determining of the basic view and the plurality of reference views among the plurality of views may include determining the basic view based on a target position indicating a position of a virtual camera of a user.

Among the plurality of views, there may be a plurality of basic views.

As a computer-readable recording medium storing a bitstream including image encoding data decoded according to an image decoding method, the image decoding method may include acquiring image data of images of a plurality of views, determining a basic view and a plurality of reference views among the plurality of views, determining a pruning order of the plurality of reference views, and parsing the image data based on the pruning order and decoding an image of the basic view and images of the plurality of reference views.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating images acquired from a plurality of views according to an embodiment of the present disclosure;

FIG. 2 is a view illustrating a process of removing redundancy between images of a plurality of views;

FIG. 3 is a view illustrating a pruning process between images of a plurality of views according to an embodiment of the present disclosure;

FIGS. 4A and 4B are views illustrating a first pruning process and a second pruning process between images of a plurality of views according to an embodiment of the present disclosure;

FIG. 5 is a view showing weight factors when calculating importance of images of a plurality of views according to an embodiment of the present disclosure;

FIG. 6 is a view showing a change in target position when calculating importance of images of a plurality of views according to an embodiment of the present disclosure;

FIG. 7 is a view illustrating a method of determining a protection mask in a pruning process of images of a plurality of views according to an embodiment of the present disclosure;

FIG. 8 is a view illustrating determination of a protection mask based on an object such as a person according to an embodiment of the present disclosure;

FIG. 9 is a view illustrating a video encoding method according to an embodiment of the present disclosure; and

FIG. 10 is a view illustrating a video decoding method according to an embodiment of the present disclosure.

### DESCRIPTION OF THE PREFERRED EMBODIMENTS

A variety of modifications may be made to the present disclosure and there are various embodiments of the present disclosure, examples of which will now be provided with reference to drawings and described in detail. However, the present disclosure is not limited thereto, although the exemplary embodiments may be construed as including all modifications, equivalents, or substitutes in a technical concept and a technical scope of the present disclosure. In the drawings, similar reference numerals refer to same or similar functions in various aspects. In the drawings, the shapes and dimensions of elements may be exaggerated for clarity. In the following detailed description of the present disclosure, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific shapes, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the embodiment. The following detailed description is, therefore, not to be taken in a limiting sense, and the scope of the exemplary embodiments is defined only by the appended claims, appropriately interpreted, along with the full range of equivalents to what the claims claim.

Terms used in the present disclosure, ‘first’, ‘second’, and the like may be used to describe various components, but the components are not to be construed as being limited to the terms. The terms are used only to differentiate one component from other components. For example, the ‘first’ component may be named the ‘second’ component without departing from the scope of the present disclosure, and the ‘second’ component may also be similarly named the ‘first’ component. The term ‘and/or’ includes a combination of a plurality of relevant items or any one of a plurality of relevant terms.

When an element is simply referred to as being ‘connected to’ or ‘coupled to’ another element in the present description, it should be understood that the former element is directly connected to or directly coupled to the latter element or the former element is connected to or coupled to the latter element, having yet another element intervening therebetween. In contrast, when an element is referred to as being “directly coupled” or “directly connected” to another element, it should be understood that there is no intervening element therebetween.

Furthermore, constitutional parts shown in the embodiments of the present disclosure are independently shown so as to represent characteristic functions different from each other. Thus, it does not mean that each constitutional part is constituted in a constitutional unit of separated hardware or software. In other words, each constitutional part includes each of enumerated constitutional parts for better understanding and ease of description. Thus, at least two constitutional parts of each constitutional part may be combined to form one constitutional part or one constitutional part may be divided into a plurality of constitutional parts to perform each function. Both an embodiment where each constitutional part is combined and another embodiment where one constitutional part is divided are also included in the scope of the present disclosure, if not departing from the essence of the present disclosure.

The terms used in the present disclosure are merely used to describe particular embodiments, and are not intended to limit the present disclosure. Singular expressions encompass plural expressions unless the context clearly indicates otherwise. In the present disclosure, it is to be understood that terms such as “include”, “have”, etc. are intended to indicate the existence of the features, numbers, steps, actions, elements, parts, or combinations thereof disclosed in the specification but are not intended to preclude the possibility of the presence or addition of one or more other features, numbers, steps, actions, elements, parts, or combinations thereof. In other words, when a specific element is referred to as being “included”, other elements than the corresponding element are not excluded, but additional elements may be included in the embodiments of the present disclosure or the technical scope of the present disclosure.

In addition, some of components may not be indispensable ones performing essential functions of the present disclosure but may be selective ones only for improving performance. The present disclosure may be implemented by including only the indispensable constitutional parts for implementing the essence of the present disclosure except the constituents used in improving performance. The structure including only the indispensable constituents except the selective constituents used in improving only performance is also included in the scope of the present disclosure.

Hereinafter, embodiments of the present disclosure will be described in detail with reference to the accompanying drawings. In describing exemplary embodiments of the present specification, well-known functions or constructions will not be described in detail since they may unnecessarily obscure the understanding of the present specification. Identical constituent elements in the drawings are denoted by identical reference numerals, and a repeated description of identical elements will be omitted.

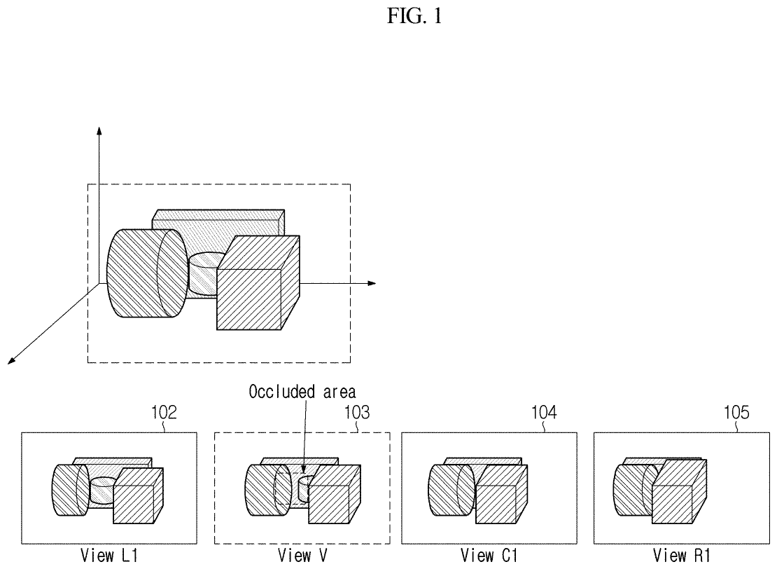

FIG. 1 is a view illustrating images acquired from a plurality of views according to an embodiment of the present disclosure. A view image may correspond to an image acquired at a corresponding view. The view image may be expressed as an image of a corresponding view.

Referring to FIG. 1, images may be acquired by a plurality of cameras having different views. View C1 104 may correspond to an image acquired at a central view. View L1 102 may correspond to an image acquired at a left view. View R1 105 may correspond to an image acquired at a right view. View V 103 may correspond to an image of a virtual view located between View L1 102 and View C1 104 using a reference view. View V 103 may include an occluded area which is not visible in View C1 104. The occluded area is partially visible in View L1 102 and thus may be referred to when images are synthesized.

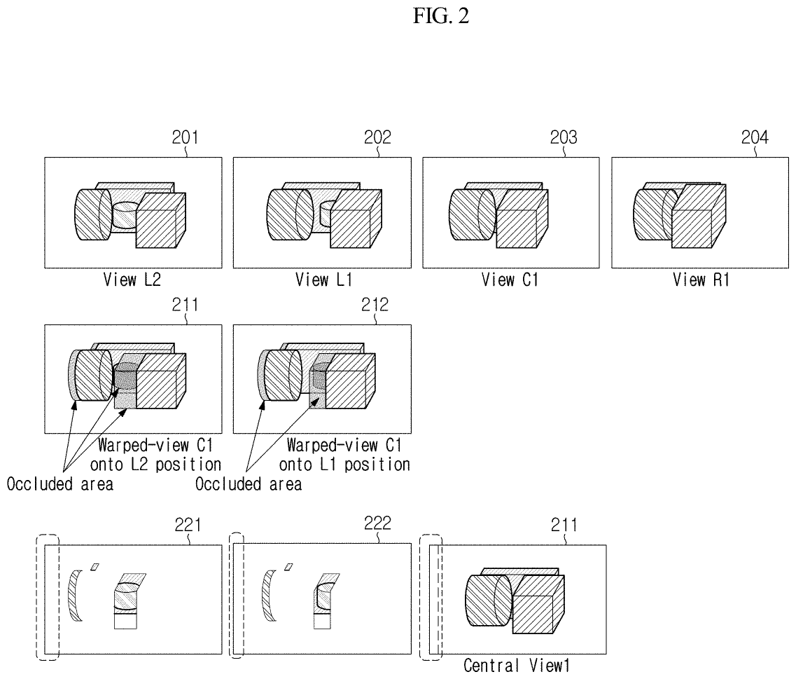

FIG. 2 is a view illustrating a process of removing redundancy between images of a plurality of views. When there are a basic view and a reference view, image data may be reduced by removing redundancy.

Referring to FIG. 2, View C1 203 may correspond to an image acquired at a central view. The remaining View L2 201, View L1 202 and View R1 204 may correspond to images acquired at reference views. View C1 203 is an image of each reference view and may be subjected to three-dimensional (3D) view warping using a 3D geometric relation and depth information. In addition, View C1 203 may be mapped to the image of each reference view.

Warped-view C1 onto L2 211 may correspond to an image generated by warping View C1 203 onto View L2 201 which is a reference view. Warped-view C1 onto L1 212 may correspond to an image generated by warping View C1 203 onto View L1 202 which is a reference view. In this case, an occluded area in View C1 203 may be generated like a black area in Warped-view C1 onto L2 211 and Warped-view C1 onto L1 212. The occluded area may be a hole area without data. The area other than the hole area may correspond to an area visible in View C1 203. In this case, redundancy may be removed through a procedure of determining whether the overlapped pixels between View L2 201 and Warped-view C1 onto L2 211 exist. In addition, redundancy may be removed through a procedure of determining whether the overlapped pixels between View L1 202 and Warped-view C1 onto L1 212 exist. As a method of removing the redundancy, texture data and depth information may be compared in units of image pixels mapped at the same coordinate or a certain range of the corresponding coordinates. In addition, Residual image 1 221 and Residual image 2 222 may be generated through the comparison.

Residual image 1 221 may correspond to an image invisible in View C1 203 and visible only in View L2 201 which is a reference view. Residual image 2 222 may correspond to an image invisible in View C1 203 and visible in View L1 202 which is a reference view.

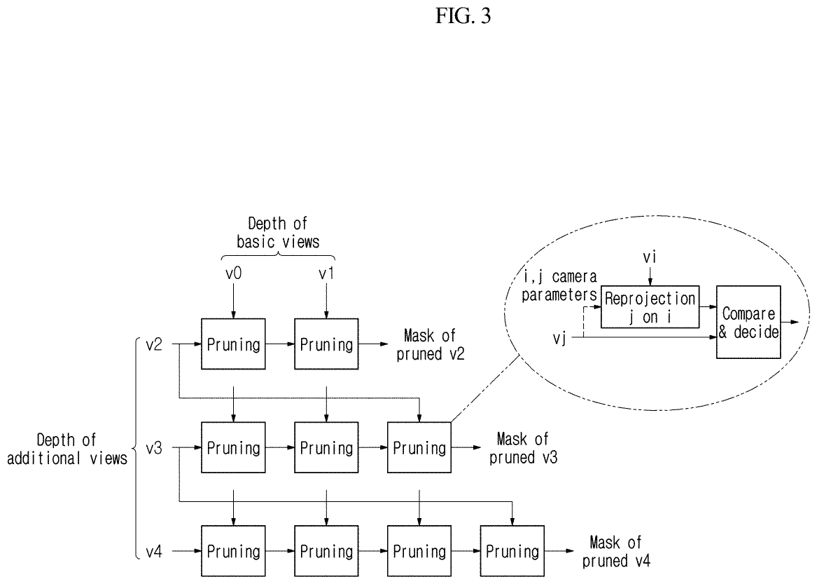

FIG. 3 is a view illustrating a pruning process between images of a plurality of views according to an embodiment of the present disclosure. Pruning may correspond to a process of removing the overlapped area between images of a plurality of views.

Referring to FIG. 3, images may be acquired at five views. A view image v0 and a view image v1 may correspond to basic view images Basic View. The remaining view images v2, v3 and v4 may correspond to additional view images Additional View. View image v0 and View image v1 are the basic view images and thus image information may be used without change. The remaining additional view images v2 to v4 may be compared with the basic view images, thereby removing redundancy. Here, when redundancy is removed, depth information and camera information may be used. Redundant pixels may be removed from the additional view images by warping the additional view images onto the basic view images using the depth information and the camera information.

Redundancy may be removed from the view image v2 based on the basic view images v0 and v1. In addition, a mask image of pruned v2 indicating only the remaining residual image information may be generated. Subsequently, redundancy may be removed from the view image v3 based on the basic view images v0 and v1. In addition, a mask image of pruned v3 may be generated. In this case, since there may be additionally redundancy with the view image v2, the pruning process may also be performed with respect to v2. Subsequently, redundancy may be removed from the view image v4 based on the basic view images v0 and v1. In addition, a mask image of pruned v4 may be generated. In this case, since there may be additionally redundancy with the view image v3, the pruning process may also be performed with respect to v3.

An image remaining in the additional view image may correspond to information invisible in the basic view image by occlusion. In such information, there may still be redundancy between the additional view images. In addition, the corresponding information may be removed in a second pruning process. In the second pruning process, the pruning pattern may vary by the pruning order of the additional view image. Accordingly, final quality and compression efficiency may vary according to the pruning pattern.

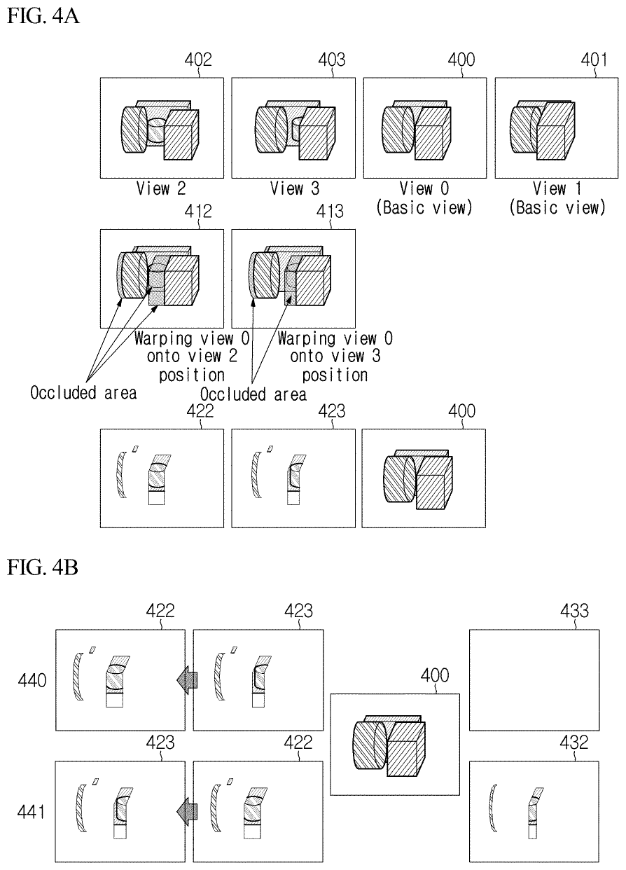

FIGS. 4A and 4B are views illustrating a first pruning process and a second pruning process between images of a plurality of views according to an embodiment of the present disclosure.

Referring to FIGS. 4A and 4B, View 0 400 and View 1 401 may correspond to basic view images. View 2 402 and View 3 403 may correspond reference view images. Warping view 0 onto view 2 412 may correspond to an image obtained by warping View 0 400 onto View 2 402 using a depth. Warping view 0 onto view 3 413 may correspond to an image obtained by warping View 0 400 onto the position of View 3 413 using a depth. In addition, an occluded area in View 0 400 may be detected from Warping view 0 onto view 2 412 and Warping view 0 onto view 3 413. In addition, when the pruning process is performed, Residual image 1 422 and Residual image 2 423 may be generated, respectively. The pruning process may correspond to a first pruning process.

After the first pruning process, a second pruning process may be performed to remove redundancy between reference view images. In the second pruning process, between Residual image 1 422 and Residual image 2 423, the pruning pattern may vary according to the pruning order. When Residual image 2 423 is pruned based on Residual image 1 422 (440), redundancy may be removed, thereby generating Residual image 3 433. In addition, the pruned image may correspond to Residual image 1 422 and Residual image 3 433. When Residual image 1 422 is pruned based on Residual image 2 423 (441), redundancy may be removed, thereby generating Residual image 4 432. In addition, the pruned image may correspond to Residual image 2 423 and Residual image 4 432.

When Residual image 2 423 is pruned based on Residual image 1 422 (440), the pruned image may be concentrated in Residual image 1 422 which is one image. On the other hand, when Residual image 1 422 is pruned based on Residual image 2 423 (441), the object of Residual image 1 422 may be divided in half and may be divisionally present in Residual image 2 423 and Residual image 4 432.

Thereafter, the pruned images may be packed in image units. The packed images may be compressed and transmitted to a terminal. The terminal may receive and decode or synthesize the packed images. Here, when image synthesis is performed, it may be advantageous in compression efficiency or image quality when one object is present in one or a smaller number of patches rather than one object being divisionally present in several patches.

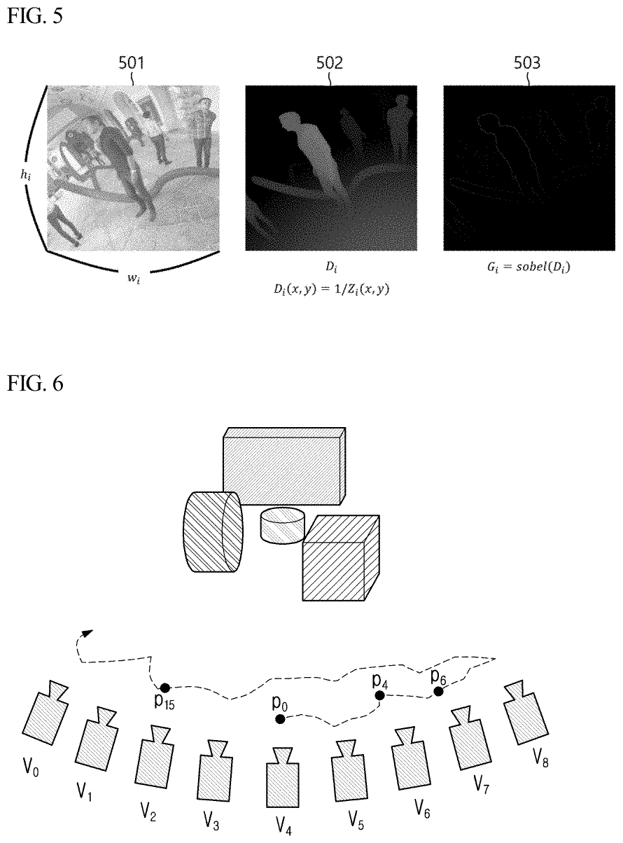

FIG. 5 is a view showing weight factors when calculating importance of images of a plurality of views according to an embodiment of the present disclosure. In the present disclosure, when determining the pruning order, a view image having high importance among a plurality of view images may be determined. The view image having high importance may be given with high priority. When the importance of the plurality of view images is calculated, the position of an object, a distance from a camera, a width of an occluded area generated in image synthesis, etc. may be considered. In addition, the importance of the plurality of view images may be calculated by giving weight according to factors. An importance calculation equation may correspond to

$${S}_{i} = {\sum }_{x} {\sum }_{y} α \cdot {W}_{i} ( x , y ) ⊗ β \cdot \vert {G}_{i} ( x , y ) \vert ⊗ γ \cdot {D}_{i} ( x , y )$$

Here, i may correspond to the number of an individual view image whose importance is calculated. x and y may correspond to the coordinate positions of a pixel of an individual view image. When the weight is calculated for each pixel, the importance of the view image may be calculated by summing the weights of all pixels.

Referring to FIG. 5, in Image 1 501, higher weight may be given as the position of an object is closer to the center of the image. An equation for calculating a weight may correspond to

$${W}_{i} ( x , y ) = \frac{1}{\sqrt{2 π {R}_{i}}} {e}^{- \frac{( {x}^{2} + {y}^{2} )}{2 {R}_{i}}} , {R}_{i} = min ( {w}_{i} , {h}_{i} ) .$$

Here, x and y may correspond to the two-dimensional coordinates of each pixel. Based on the assumption that a probability that an area of interest or an object corresponding to the object of interest is located in the middle of the camera in a scene, a weight may be calculated in consideration of a distance from the center for each pixel as in Image 1 501. Image 2 502 may correspond to a depth image of Image 1 501. In Image 2 502, a degree of parallax and width of an occluded area which is generated during warping on an x-axis and a y-axis may vary according to the depth of an individual foreground or background. Accordingly, a depth value may be considered when calculating the importance of the view image. This is because an important object in a scene is likely to be closer to the camera. When an object belonging to a foreground is warped, an area occluded by the object may be generated. The area may be covered by the foreground objects. Alternatively, the area may be proportional to a difference in depth value between adjacent background pixels. That is, the larger the depth difference between the foreground and the background, the wider or the longer the occluded area is generated. In Image 3 503, in order to represent the depth difference between the foreground and the background, the depth difference may be calculated in a boundary portion through a Sobel operation. In the importance calculation equation, α, β and γ may correspond to weights applied to each term in importance calculation.

The importance calculation equation may be used in many cases. In FIG. 3, a view image determined to have high importance in the pruning process of a plurality of view images may have high priority. Therefore, a view image having high importance among the view images may be less pruned. Being less pruned may mean that the number of pixels in which redundancy is removed through the pruning process is small. Therefore, a view image having low importance among the view images may be more pruned. Being more pruned mean that the number of pixels in which redundancy is removed through the pruning process is large.

FIG. 6 is a view showing a change in target position when calculating importance of images of a plurality of views according to an embodiment of the present disclosure.

Referring to FIG. 6, 9 cameras, from Camera 0 to Camera 8, may capture view images at respective positions. An image at a target virtual view may be synthesized using view images acquired through simultaneous capturing. In this case, a target position may be changed from a position p0 to a position p15 through p4 and p6 according to the time axis. The target position may indicate the position of a virtual camera viewed by a user. In addition, the tracking coordinates of the virtual camera moving along the time axis may be defined as a pose trace. The pose trace may correspond to the coordinates of a target virtual view image that a user moves arbitrarily when the user views a view image synthesized in a terminal. In addition, the coordinates may correspond to predicted motion coordinates of a user, which are predefined according to the intention of a manufacturer or as motion of the user acquired by the terminal is sent to an encoder of a server.

At this time, three-dimensional x, y and z coordinates of the virtual camera at the target position may be translated. In addition, a pose which is a rotation angle at which the virtual camera looks at a scene may also be changed. When the target position is changed, the number of reference view images or importance of each view image may be changed. Here, high priority may be given to a view image having a high correlation with the target position. The view image given with high priority may be less pruned.

In addition, even when a basic view image is selected, a view having a high correlation with the target position may be selected as a basic view. In addition, information on the basic view may be transmitted as metadata. The basic view image may correspond to an image of a view used as a reference for pruning. Redundancy may be removed from reference view images through a pruning process by referring to the pixel of the basic view image.

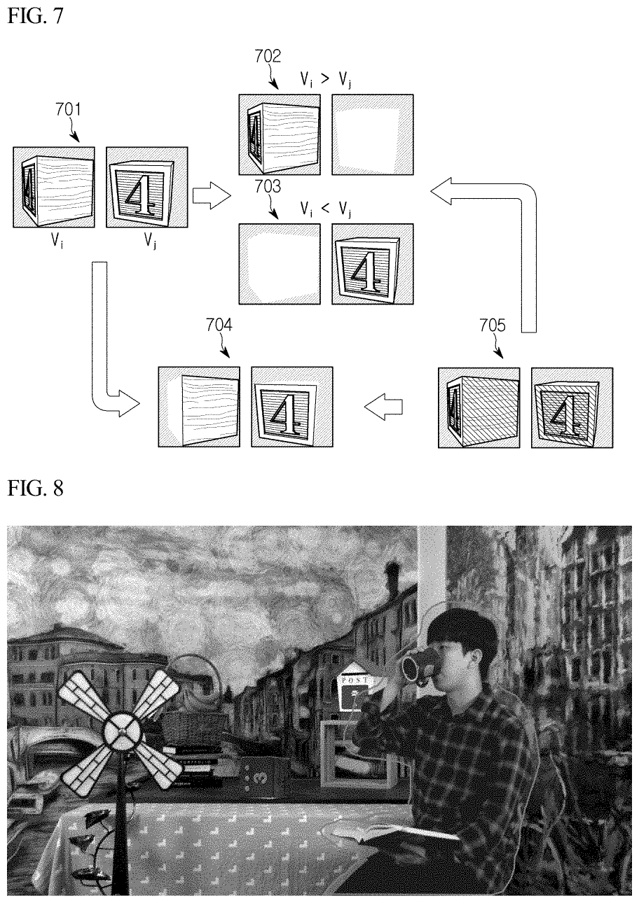

FIG. 7 is a view illustrating a method of determining a protection mask in a pruning process of images of a plurality of views according to an embodiment of the present disclosure.

Referring to FIG. 7, 701 may include Vᵢ and Vⱼ which are view images obtained by photographing one object at different positions. When Vᵢ has higher priority than Vⱼ, pruning may be performed like 702. Conversely, when Vᵢ has lower priority than Vⱼ, pruning may be performed like 703. In 701, Vᵢ may have little texture information of a number surface 4 and a lot of texture information of a side surface. Vⱼ may have little texture information of a side surface and a lot of texture information of a number surface 4. In 704, a lot of texture information of Vᵢ and V₁ may be preserved and the texture information of an area having low importance may be removed. When pruning is performed like 704, good results may be obtained in image synthesis. In order to perform pruning like 704, a protection mask may be designated at places determined as important areas in Vᵢ and Vⱼ in advance like 705. When the protection mask is designated like 705, the corresponding areas may be preserved without being pruned regardless of the priority of the view image in the pruning process. That is, when the protection mask is designated at the side surface in Vᵢ and the protection mask is designated at the number surface 4 in Vⱼ in 705, pruning may be performed like 704.

FIG. 8 is a view illustrating determination of a protection mask based on an object such as a person according to an embodiment of the present disclosure. For example, the protection mask may have a shape such as a polygon such as a triangle or a rectangle or a shape such as a circle. For example, a user may freely designate the protection mask in an arbitrary shape. For example, the protection mask may be automatically designated by a computer vision algorithm. For example, the user may designate an area which causes user's observation or user's interest while viewing an image synthesized in the terminal and transmit the area to a server as separate metadata, thereby designating the protection mask. For example, the protection mask may correspond to an object mask image of a person or object separated from a background in a scene. In addition, this may correspond to a second mask image generated based on the object mask image. However, the present disclosure is not limited to the above embodiment.

Referring to FIG. 8, an area of a person in the image may correspond to an area of interest or an important area. Therefore, the area of the person may be designated as a protection mask. Therefore, in the pruning process, the region of the person designated as the protection mask may be excluded from an object to be pruned. An area synthesized by pixels excluded from the object to be pruned may have relatively improved synthesis quality compared to the other areas.

FIG. 9 is a view illustrating a video encoding method according to an embodiment of the present disclosure.

Referring to FIG. 9, images of a plurality of views may be acquired (S910).

In addition, among the plurality of views, a basic view and a plurality of reference views may be determined (S920).

According to an embodiment, the basic view may be determined based on a change in target position indicating the position of a virtual camera of a user.

According to an embodiment, among the plurality of views, there may be a plurality of basic views.

According to an embodiment, information on the basic view may be transmitted as metadata as separate information.

In addition, a pruning order of the plurality of reference views may be determined (S930).

According to an embodiment, importance of the plurality of views may be determined and the pruning order of the plurality of reference views may be determined based on the importance.

According to an embodiment, a weight may be given to each pixel in the images of the plurality of reference views and importance of the plurality of reference views may be determined based on the weight.

According to an embodiment, the weight may be given to each pixel in the image based on at least one of the position of an object, a distance from a camera or width and depth values of an occluded area.

According to an embodiment, the importance of the plurality of reference views may be determined based on a change in target position indicating the position of the virtual camera of the user.

In addition, pruning may be performed between the image of the basic view and the images of the plurality of reference views based on the pruning order (S940).

According to an embodiment, a protection mask may be determined based on an important area of the images of the plurality of views.

According to an embodiment, an area determined as the protection mask may not be pruned.

According to an embodiment, the protection mask may have an arbitrary shape.

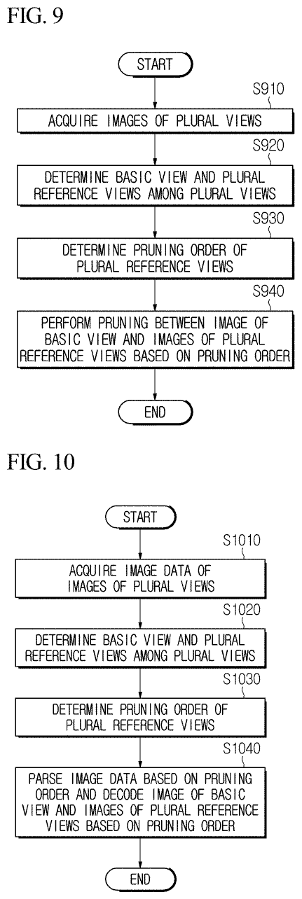

FIG. 10 is a view illustrating a video decoding method according to an embodiment of the present disclosure.

Referring to FIG. 10, image data of images of a plurality of views may be acquired (S1010).

In addition, among the plurality of views, a basic view and a plurality of reference views may be determined (S1020).

According to an embodiment, the basic view may be determined based on a change in target position indicating the position of a virtual camera of a user.

According to an embodiment, among the plurality of views, there may be a plurality of basic views.

In addition, a pruning order of the plurality of reference views may be determined (S1030).

According to an embodiment, importance of the plurality of views may be determined and the pruning order of the plurality of reference views may be determined based on the importance.

According to an embodiment, a weight may be given to each pixel in the images of the plurality of reference views and importance of the plurality of reference views may be determined based on the weight.

According to an embodiment, the weight may be given to each pixel in the image based on at least one of the position of an object, a distance from a camera or width and depth values of an occluded area.

According to an embodiment, the importance of the plurality of reference views may be determined based on a change in target position indicating the position of the virtual camera of the user.

In addition, image data may be parsed based on the pruning order and the image of the basic view and the images of the plurality of reference views may be decoded (S1040).

According to an embodiment, a protection mask may be determined based on an important area of the images of the plurality of views.

According to an embodiment, an area determined as the protection mask may not be pruned.

According to an embodiment, the protection mask may have an arbitrary shape.

According to an embodiment, a computer-readable recording medium storing a bitstream including image encoding data decoded according to an image decoding method may be provided.

In addition, according to the present disclosure, it is possible to provide a video encoding/decoding method and apparatus for determining a pruning order of a plurality of view images. In addition, according to the present disclosure, it is possible to provide a video encoding/decoding method and apparatus for determining importance of a plurality of view images.

In addition, according to the present disclosure, it is possible to provide a video encoding/decoding method and apparatus capable of efficiently managing image data.

In addition, according to the present disclosure, it is possible to provide a video encoding/decoding method and apparatus for providing a natural omnidirectional video.

In addition, according to the present disclosure, it is possible to provide a video encoding/decoding method and apparatus capable of improving image compression efficiency and image synthesis quality.

In the above-described embodiments, the methods are described based on the flowcharts with a series of steps or units, but the present disclosure is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present disclosure.

The above-described embodiments include various aspects of examples. All possible combinations for various aspects may not be described, but those skilled in the art will be able to recognize different combinations. Accordingly, the present disclosure may include all replacements, modifications, and changes within the scope of the claims.

The embodiments of the present disclosure may be implemented in a form of program instructions, which are executable by various computer components, and be recorded in a computer-readable recording medium. The computer-readable recording medium may include stand-alone or a combination of program instructions, data files, data structures, etc. The program instructions recorded in the computer-readable recording medium may be specially designed and constructed for the present disclosure, or well-known to a person of ordinary skill in the computer software technology field. Examples of the computer-readable recording medium include magnetic recording media such as hard disks, floppy disks and magnetic tapes; optical data storage media such as CD-ROMs and DVD-ROMs; magneto-optimum media like floptical disks; and hardware devices, such as read-only memory (ROM), random-access memory (RAM), flash memory, etc., which are particularly structured to store and implement program instructions. Examples of the program instructions include not only a mechanical language code formatted by a compiler but also a high-level language code that may be implemented by a computer using an interpreter. In order to implement processes according to the present disclosure, the hardware devices may be configured to be operable through one or more software modules or vice versa.

Although the present disclosure has been described in terms of specific items such as detailed elements as well as the limited embodiments and the drawings, they are only provided to help more general understanding of the invention, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the invention.

What is claimed is:

1. A video encoding method comprising:
acquiring images of a plurality of views;
determining a basic view and a plurality of reference views among the plurality of views;
determining a pruning order of the plurality of reference views; and
performing pruning between an image of the basic view and images of the plurality of reference views based on the pruning order.

2. The video encoding method according to claim 1, further comprising determining a protection mask based on an important area of the images of the plurality of views.

3. The video encoding method according to claim 2, wherein an area determined as the protection mask is not pruned.

4. The video encoding method according to claim 2, wherein the protection mask has an arbitrary shape.

5. The video encoding method according to claim 1, wherein the determining of the pruning order of the plurality of reference views comprises:
determining importance of the plurality of reference views; and
determining the pruning order of the plurality of reference views based on the importance.

6. The video encoding method according to claim 5, wherein the determining of the importance of the plurality of reference views comprises:
giving a weight to each pixel in the images of the plurality of reference views; and
determining the importance of the plurality of reference views based on the weight.

7. The video encoding method according to claim 6, wherein the giving of the weight comprises giving the weight to each pixel in the image based on at least one of a position of an object, a distance from a camera or width and depth values of an occluded area.

8. The video encoding method according to claim 5, wherein the determining of the importance of the plurality of reference views comprises determining the importance of the plurality of reference views based on a target position indicating a position of a virtual camera of a user.

9. The video encoding method according to claim 1, wherein the determining of the basic view and the plurality of reference views among the plurality of views comprises determining the basic view based on a change in target position indicating a position of a virtual camera of a user.

10. A video decoding method comprising:
acquiring image data of images of a plurality of views;
determining a basic view and a plurality of reference views among the plurality of views;
determining a pruning order of the plurality of reference views; and
parsing the image data based on the pruning order and decoding an image of the basic view and images of the plurality of reference views.

11. The video decoding method according to claim 10, further comprising determining a protection mask based on an important area of the images of the plurality of views.

12. The video decoding method according to claim 11, wherein an area determined as the protection mask is not pruned.

13. The video decoding method according to claim 11, wherein the protection mask has an arbitrary shape.

14. The video decoding method according to claim 10, wherein the determining of the pruning order of the plurality of reference views comprises:
determining importance of the plurality of reference views; and
determining the pruning order of the plurality of reference views based on the importance.

15. The video decoding method according to claim 14, wherein the determining of the importance of the plurality of reference views comprises:
giving a weight to each pixel in the images of the plurality of reference views; and
determining the importance of the plurality of reference views based on the weight.

16. The video decoding method according to claim 15, wherein the giving of the weight comprises giving the weight to each pixel in the image based on at least one of a position of an object, a distance from a camera or width and depth values of an occluded area.

17. The video decoding method according to claim 14, wherein the determining of the importance of the plurality of reference views comprises determining the importance of the plurality of reference views based on a change in target position indicating a position of a virtual camera of a user.

18. The video decoding method according to claim 10, wherein the determining of the basic view and the plurality of reference views among the plurality of views comprises determining the basic view based on a target position indicating a position of a virtual camera of a user.

19. The video decoding method according to claim 10, wherein, among the plurality of views, there is a plurality of basic views.

20. A computer-readable recording medium storing a bitstream including image encoding data decoded according to an image decoding method, the image decoding method comprising:
acquiring image data of images of a plurality of views;
determining a basic view and a plurality of reference views among the plurality of views;
determining a pruning order of the plurality of reference views; and
parsing the image data based on the pruning order and decoding an image of the basic view and images of the plurality of reference views.
